(19) United States
(12) Patent Application Publication
(10) Pub. No.: US 2014/0182684 A1
(43) Pub. Date: Jul. 3, 2014

(54) Refrigerant Removal Device and Method

(71) Applicant: SERVICE SOLUTIONS U.S. LLC, Warren, MI (US)

(72) Inventor: Mark McMASTERS, Owatonna, MN (US)

(73) Assignee: SERVICE SOLUTIONS U.S. LLC, Warren, MI (US)

(21) Appl. No.: 13/731,412

(22) Filed: Dec. 31, 2012

(51) Int. Cl. F17D 1/08

(52) U.S. Cl. CPC F17D 1/08
USPC 137/1; 137/334

(57) ABSTRACT

A refrigerant recovery system includes a recovery apparatus and a refrigerant recovery unit. The recovery apparatus includes a heat sink, a capture tank, and a hose. The capture tank is in thermal contact with the heat sink. The capture tank is configured to capture a first refrigerant from a refrigeration system. The hose is to fluidly connect the capture tank to the refrigerant system. The refrigerant recovery unit includes a refrigerant storage unit, a refrigerant circuit, a processor and a memory. The refrigerant storage unit is configured to store a second refrigerant. The refrigerant circuit is in fluid connection with the heat sink. The refrigerant circuit is configured to circulate the second refrigerant through the heat sink, a compressor, and a condenser. The processor is configured to control the refrigerant recovery unit. The memory is to store diagnostic software and operating software to operate the refrigerant recovery unit.

### FIELD OF THE INVENTION

The disclosure generally relates to a refrigerant recovery unit. More particularly to an improved refrigerant recovery unit that collects a higher percentage of refrigerant from a cooling system than conventional refrigerant recovery units.

### BACKGROUND OF THE INVENTION

Portable refrigerant recovery units or carts are used in connection with the service and maintenance of refrigeration systems, such as a vehicle's air conditioning system. The refrigerant recovery unit connects to the air conditioning system of the vehicle to recover refrigerant out of the system, separate out oil and contaminants from the refrigerant in order to recycle the refrigerant, and recharge the system with additional refrigerant.

Vehicle data, such as vehicle manufacturer, make and model are manually entered into the refrigerant recovery unit in order to properly service the vehicle. Taking time to enter vehicle information can be inefficient and the information may be entered incorrectly. Additionally, vehicle diagnostic data can be useful to servicing the vehicle, however, this is not currently be collected by a refrigerant recovery unit.

Accordingly, it is desirable to provide an improved refrigerant recovery device and method.

### SUMMARY OF THE INVENTION

The foregoing needs are met, to a great extent, by the present invention, wherein in one respect a refrigerant recovery system is provided.

An embodiment of the present invention pertains to a refrigerant recovery system. The refrigerant recovery system includes a recovery apparatus and a refrigerant recovery unit. The recovery apparatus includes a heat sink, a capture tank, and a hose. The capture tank is in thermal contact with the heat sink. The capture tank is configured to capture a first refrigerant from a refrigeration system. The hose is to fluidly connect the capture tank to the refrigerant system. The refrigerant recovery unit includes a refrigerant storage unit, a refrigerant circuit, a processor and a memory. The refrigerant storage unit is configured to store a second refrigerant. The refrigerant circuit is in fluid connection with the heat sink. The refrigerant circuit is configured to circulate the second refrigerant through the heat sink, a compressor, and a condenser. The processor is configured to control the refrigerant recovery unit. The memory is to store diagnostic software and operating software to operate the refrigerant recovery unit.

Another embodiment of the present invention relates to a recovery device. The recovery device includes a heat sink, a capture tank and a hose. The capture tank is in thermal contact with the heat sink. The capture tank is configured to capture a first refrigerant from a refrigeration system. The hose is to fluidly connect the capture tank to the refrigerant system.

Yet another embodiment of the present invention pertains to a method of recovering contaminated or flammable refrigerant from a refrigeration system. In this method, a capture tank is cooled to a temperature below a condensing temperature of a first refrigerant and the capture tank is thermally connected to the refrigeration system. In addition, a pressure differential is generated with a relatively low pressure in the capture tank by condensing the first refrigerant that enters the capture tank and causing the first refrigerant in the refrigeration system to flow into the capture tank.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a refrigerant recovery unit in accordance with an embodiment of the invention.

FIG. 2 is a schematic diagram illustrating components of the refrigerant recovery unit shown in FIG. 1 in accordance with an embodiment of invention.

FIG. 3 is a block diagram illustrating aspects of a control system, in accordance with an embodiment of the present invention.

### DETAILED DESCRIPTION

According to various embodiments described herein, a refrigerant recovery system is provided that facilitates the servicing of a refrigeration system. As used herein, the term, “servicing” refers to any suitable procedure performed on a refrigeration system such as, for example, recovering refrigerant, testing refrigerant, leak testing the refrigeration system, recharging refrigerant into the refrigeration system, purifying the refrigerant to remove contaminants, recovering the lubricant, replacing the lubricant, and the like. In an embodiment, the refrigerant recovery system disclosed herein may be used to recover refrigerant that is contaminated. In this or other embodiments, the refrigerant recovery system described herein may recover this contaminated refrigerant without co-mingling the contaminated refrigerant with clean refrigerant. In this or other embodiments, the refrigerant recovery system described herein may recover this contaminated refrigerant without subjecting the contaminated refrigerant to a potential ignition source. In this regard, one potential contaminant of refrigerant is propane, which is generally known to be flammable. In addition, some refrigerants are generally considered to be flammable and the refrigerant recovery system described herein may be configured to capture this flammable refrigerant without subjecting the refrigerant to mechanical compression.

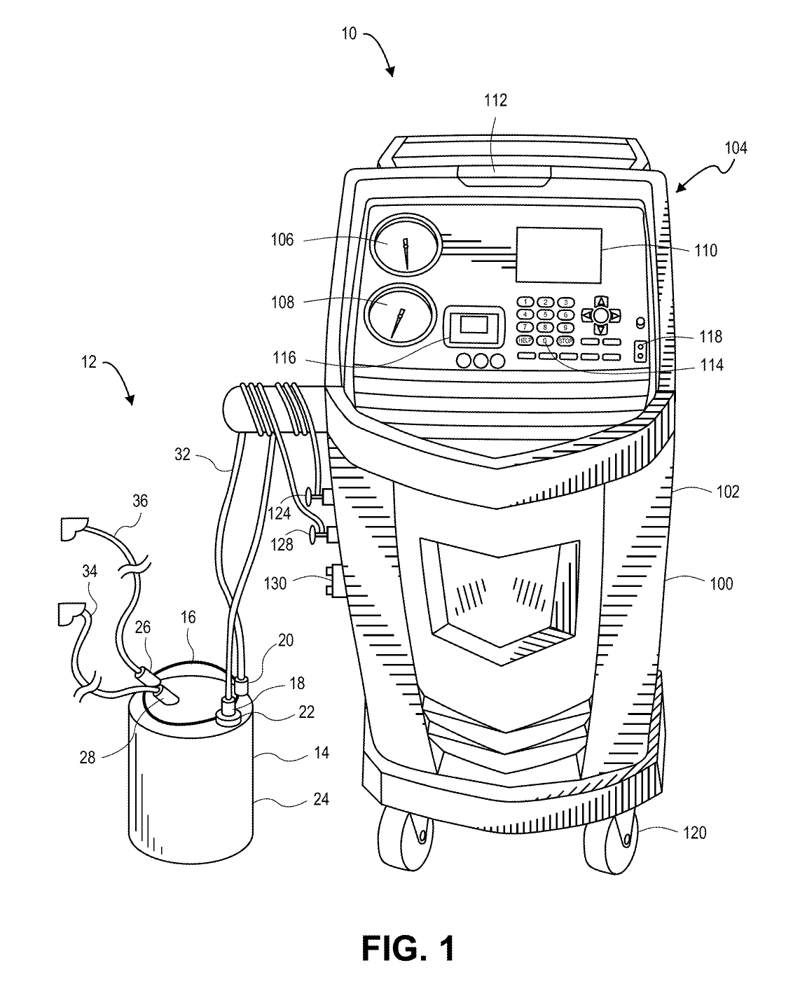

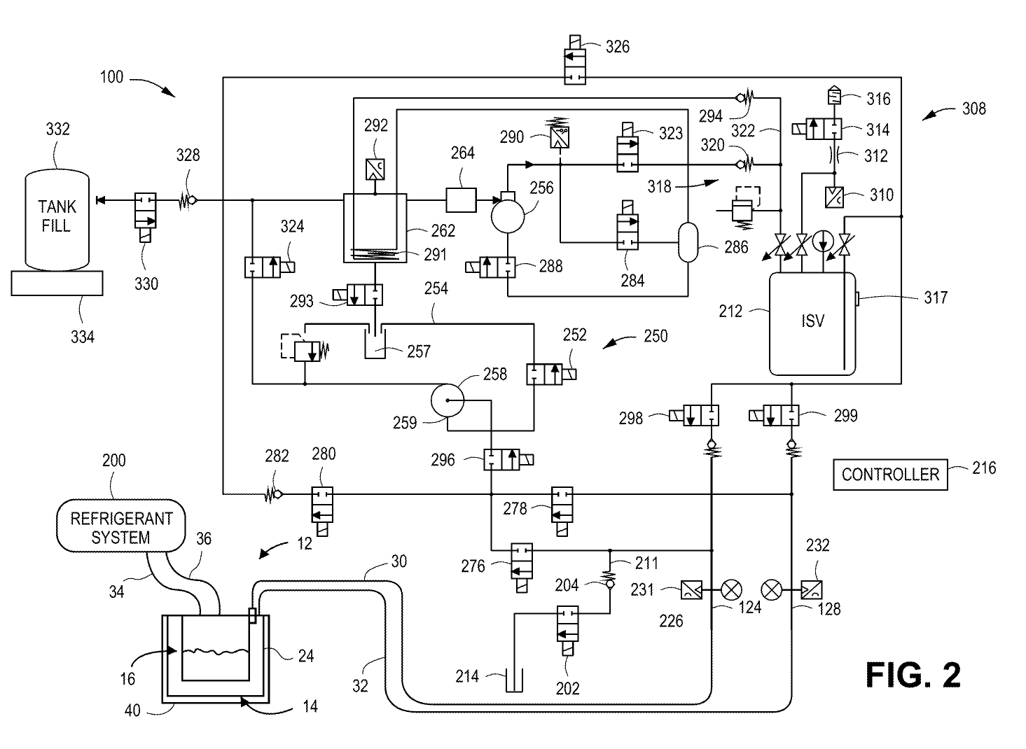

As shown in FIG. 1, a refrigerant recovery system 10 includes a recovery apparatus 12. The recovery apparatus 12 includes a heat sink 14 and a capture tank 16. The heat sink 14 includes a pair of connectors 18 and 20, an expansion valve 22, and an evaporator 24. The heat sink 14 is in thermal contact with the capture tank 16. The capture tank 16 includes one or more connectors 26 and 28 that are configured to provide fluid communication with a refrigeration system (shown in FIG. 2). The recovery apparatus 12 includes a pair of hoses 30 and 32 to connect the pair of connectors 18 and 20 to a refrigerant recovery unit 100. The recovery apparatus 12 optionally includes a pair of hoses 34 and 36 to connect the pair of connectors 26 and 28 to the refrigeration system (shown in FIG. 2). In various embodiments, the refrigeration system may be a standalone unit and/or disposed within a vehicle, device, appliance, structure, or the like. A vehicle can be any suitable vehicle, such as an automobile, train, airplane, boat, ship and the like. Suitable devices or appliances may include, for example, an air conditioning unit, dehumidifier, ice maker, refrigerator/freezer, beverage dispenser, ice cream maker, and the like.

The refrigerant recovery unit 100 can be the AC1234™ from ROBINAIR® based in Owatonna, Minn. (Service Solutions U.S., LLC). The refrigerant recovery unit 100 includes a cabinet 102 to house components of the system (See FIG. 2). The cabinet 102 may be made of any suitable material such as thermoplastic, steel and the like.

The cabinet 102 includes a control panel 104 that allows the user to operate the refrigerant recovery unit 100. The control panel 104 may be part of the cabinet as shown in FIG. 1 or separated. The control panel 104 includes high and low gauges 106, 108, respectively. For the purposes of this disclosure, the terms, “high” and “low” generally refer to the high and low pressure sides of a refrigeration system, respectively. The gauges may be analog or digital. The control panel 104 has a display 110 to provide information to a user. The information may include, for example, operating status of the refrigerant recovery unit 100 or provide messages or menus to the user. The control panel 104 may include indicators 112 to indicate to the user the operational status of the refrigerant recovery unit 100. If included, the indicators 112 may include light emitting diodes (LEDs) or the like, that when activated, may indicate that the refrigerant recovery unit 100 is in the recovery, recycling or recharging mode or indicate that the filter needs to be changed or that there is a malfunction.

According to an embodiment, the control panel 104 includes a user interface 114 to provide the user with an interface to interact and operate the refrigerant recovery unit 100. The user interface 114 may include any suitable interface such as, for example, an alphanumeric keypad, directional arrows, function keys, pressure or touch sensitive display, and the like. Optionally, a printer 116 is provided to print out information, such as test results.

The cabinet 102 further includes connections 124, 128 for hoses 30, 32 that connect the refrigerant recovery unit 100 to a refrigerant containing device, such as the recovery apparatus 12 and/or a refrigerant system (shown in FIG. 2). Also shown in FIG. 1, a vehicle connector interface 130 is provided so that a communication cable can be connected from the vehicle connector interface to a data link connector in a vehicle (not shown in FIG. 1). This allows the refrigerant recovery unit 100 to communicate with the vehicle and diagnose any issues with it. In order for the refrigerant recovery unit 100 to be mobile, one or more wheels 120 are provided at a bottom portion of the cabinet 102.

During servicing of a refrigeration system (shown in FIG. 2), if it is determined that the refrigerant therein should not be mixed with the supply of refrigerant in the refrigeration recovery unit 100 (e.g., the refrigerant is different, contaminated, flammable, etc.), the recovery apparatus 12 may be used to capture the refrigerant while keeping it isolated from the refrigerant in the refrigerant recovery unit 100. For example, the refrigeration system is connected to the capture tank 16 and the refrigerant recovery unit 100 is connected to the heat sink 14.

In operation, the recovery apparatus 12 is utilized to collect refrigerant from a refrigeration system (shown in FIG. 2). For example, one or both of the hoses 34 and 36 may be connected to the refrigeration system and the refrigerant recovery unit 100 provides cooling capacity to the recovery apparatus 12 to condense the refrigerant being recovered from the refrigeration system. Once the refrigerant has been recovered from the refrigeration system, the refrigeration system may be recharged. For example, the hoses 34 and 36 may be disconnected from the refrigeration system and the hoses 30 and 32 may disconnected from the recovery apparatus 12. The hoses 30 and 32 may then be connected directly to the refrigeration system and a suitable amount of a suitable refrigerant may be supplied to the refrigeration system by the refrigerant recovery unit 100.

FIG. 2 illustrates components of the refrigerant recovery system 10 of FIG. 1 according to an embodiment of the present disclosure. In general, the refrigerant recovery unit 100 is configured to facilitate testing, removing, and recharging refrigerant and/or lubricant in a refrigeration system 200. In addition, the refrigerant recovery unit 100 may be configured to purify some types of contaminants from refrigerant recovered from the refrigeration system 200. However, in response to regulation and/or certain types of contamination, it may be determined that refrigerant from the refrigeration system 200 should not enter the refrigerant recovery unit 100. In such instances, the recovery apparatus 12 provides the capability of recovering the refrigerant from the refrigeration system 200 and collecting the refrigerant in the capture tank 16 while keeping the recovered refrigerant isolated from the refrigerant recovery unit 100. In this or other embodiments, contaminated and/or potentially flammable refrigerant may be removed from the refrigeration system 200 without contaminating the refrigerant recovery unit 100 and/or exposing the contaminated and/or potentially flammable refrigerant to an ignition source such as, for example, a compressor.

In the particular example shown, the refrigerant recovery unit 100 is coupled to the recovery apparatus 12 via the hoses 30 (high side) and 32 (low side) and the recovery apparatus 12 is coupled to the refrigerant system 200 via the hoses 34 and 36. In general, the various hoses and couplers are configured to be closed until they are coupled to the refrigerant recovery unit 100, the recovery apparatus 12, and/or the refrigerant system 200. In this manner, refrigerant leakage may be minimized or prevented.

Prior to recovering refrigerant from the refrigerant system 200, the capture tank 16 may be pre-chilled by cooling the heat sink 14. For example, by the opening of high pressure and low-pressure solenoids 298, 299, respectively, the refrigerant within the refrigerant recovery unit 100 may be allowed to flow into the heat sink 14 and remove heat from the heat sink 14. In one example, the refrigerant recovery unit 100 may supply liquid refrigerant to the heat sink 14 and simply draw off refrigerant vapor. In this example, the expansion valve 22 may be omitted which simplifies the heat sink 14. The supply of refrigerant may be supplied as: a single, predetermined, amount of refrigerant; two or more predetermined amounts, or a continuous flow. The predetermined amount may be based on the volume of the heat sink 14, for example. In another example, relatively high pressure refrigerant that is predominantly liquid is driven through the hose 30 and sprayed into the heat sink 14 via the expansion valve 22. In various examples, the expansion valve 22 may include a restriction of a predetermined size, a thermostatic expansion valve, and/or an electronic expansion valve. However, regardless of the particular type of expansion valve, the expansion valve 22 is configured to control the flow of refrigerant into the heat sink 14 such that the refrigerant may vaporize and absorb heat from the heat sink 14. To maintain a predetermined pressure differential across the expansion valve 22, refrigerant may be drawn from the heat sink 14 via the hose 32. In general, the refrigerant within the refrigerant recovery unit 100 may be controlled to circulate through the action of a compressor 256. The compressed refrigerant is then controlled to pass through a heat exchanger 291 to cool and condense the refrigerant before being urged to flow through the heat sink 14 again. To maintain the chilled conditions (relative to ambient temperature) achieved by the cycling of the refrigerant through the heat sink 14, an insulating jacket 40 may be disposed about the recovery apparatus 12.

More particularly, the refrigerant drawn from the heat sink 14 may be urged to flow through a recovery valve 280 and a check valve 282. The refrigerant flows from the check valve 282 into a system oil separator 262, where it travels through a filter/dryer 264, to an input of a compressor 256. Refrigerant is drawn through the compressor 256 through a normal discharge solenoid 284 and through a compressor oil separator 286, which circulates oil back to the compressor 256 through an oil return valve 288. The refrigerant recovery unit 100 may include a high-pressure switch 290 in communication with a controller 216, which is programmed to determine an upper pressure limit, for example, 435 psi, to optionally shut down the compressor 256 to protect the compressor 256 from excessive pressure. The controller 216 can also be, for example, a microprocessor, a field programmable gate array (FPGA) or application-specific integrated circuit (ASIC). The controller 216 via a wired or wireless connection (not shown) controls the various valves and other components (e.g. vacuum, compressor) of the refrigerant recovery unit 100. In some embodiments of the present disclosure, any or all of the electronic solenoid or electrically activated valves may be connected and controlled by the controller 216.

A high-side clear solenoid 323 may optionally be coupled to the output of the compressor 256 to release the recovered refrigerant transferred from compressor 256 directly into a storage tank 212, instead of through a path through the normal discharge solenoid 284.

The heated compressed refrigerant exits the oil separator 286 and then travels through a loop of conduit or heat exchanger 291 for cooling or condensing. As the heated refrigerant flows through the heat exchanger 291, the heated refrigerant gives off heat to the cold refrigerant in the system oil separator 262, and assists in maintaining the temperature in the system oil separator 262 within a working range. Coupled to the system oil separator 262 is a switch or transducer 292, such as a low pressure switch or pressure transducer, for example, that senses pressure information, and provides an output signal to the controller 216 through a suitable interface circuit programmed to detect when the pressure of the recovered refrigerant is down to 13 inches of mercury, for example. An oil separator drain valve 293 drains the recovered oil into a container 257. The circulating refrigerant flows through a normal discharge check valve 294, into the storage tank 212 and finally out of the storage tank 212 and through a discharge valve 298 to be reintroduced to the heat sink 14.

Once the capture tank 16 has been pre-chilled, refrigerant from the low pressure side of the refrigeration system 200 may be collected via the hose 36. In general, the temperature of the capture tank 16 is maintained near or relatively below the condensation temperature of the refrigerant via the heat sink 14. In this manner, as refrigerant flows from the refrigeration system 200, the volume is reduced. This reduction in volume lowers the pressure relative to the refrigeration system 200 which, in turn, draws more refrigerant from the refrigeration system 200. In a similar manner, refrigerant from the high pressure side of the refrigeration system 200 may be collected in the capture tank 16 via the hose 34. Optionally, the refrigerant system 200 may be heated in any suitable manner to further drive the refrigerant into the capture tank 16.

Of note, the recovery apparatus 12 need not be coupled to the refrigerant recovery unit 100, but rather, the heat sink 14 may be configured to remove heat from the capture tank 16 in any suitable manner. Examples of suitable devices and methods of heat removal include piezoelectric coolers, pre-chilled thermal masses, other mechanical, electrical and/or chemical cooling system, and the like.

Following capture of the refrigerant from the refrigeration system 200, an evacuation cycle is optionally performed. Prior to the optional evacuation cycle, the recovery apparatus 12 is detached from the refrigerant system 200 and the refrigerant recovery unit 100 and the refrigerant recovery unit 100 is directly connected to the refrigerant system 200 via the hoses 30 and 32.

The optional evacuation cycle begins by the opening of high pressure and low-pressure solenoids 276 and 278 and valve 296, leading to the input of a vacuum pump 258. The vehicle's refrigerant system 200 is then evacuated by the closing of the air intake valve and opening the valve 296, allowing the vacuum pump 258 to exhaust any trace gases remaining until the pressure is approximately 29 inches of mercury, for example. When this occurs, as detected by pressure transducers 231 and 232, optionally, coupled to the high side and low side of the vehicle's refrigeration system 200 and to the controller 216, the controller 216 turns off valve 296 and this begins the recharging cycle.

The recharging cycle begins by opening charge valve 298 to allow the refrigerant in storage tank 212, which is at a pressure of approximately 70 psi or above, to flow through the high side of the vehicle's refrigeration system 200. The flow is through charge valve 298 for a period of time programmed to provide a full charge of refrigerant to the vehicle. Optionally, charge valve 299 may be opened to charge the low side. The charge valve 299 may be opened alone or in conjunction with charge valve 298 to charge the vehicle's refrigerant system 200. The storage tank 212 may be disposed on a scale (not shown) that measures the weight of the refrigerant in the storage tank.

Other components shown in FIG. 2 include an oil inject circuit having an oil inject valve 202 and an oil inject hose or line 211. The oil inject hose 211 is one example of a fluid transportation means for transmitting oil for the refrigerant recovery unit 100. The oil inject hose 211 may be one length of hose or multiple lengths of hose or tubing or any other suitable means for transporting fluid. The oil inject hose 211 connects on one end to an oil inject bottle 214 and on the other end couples to the refrigerant circuit in the refrigerant recovery unit 100. Disposed along the length of the oil inject hose 211 are the oil inject valve 202 and an oil check valve 204. The oil inject path follows from the oil inject bottle 214, through the oil inject solenoid 202, to the junction with the high side charge line, and to the vehicle's refrigerant system 200.

FIG. 2 also illustrates a vacuum pump oil drain circuitry 250 that includes a vacuum pump oil drain valve 252 that is located along a vacuum pump oil drain conduit 254 connecting a vacuum pump oil drain outlet 259 to the container 257 for containing the drained vacuum pump oil. The vacuum pump oil drain valve 252 may be an electronically activated solenoid valve controlled by controller 216. The connection may be a wireless or wired connection. In other embodiments the valve 252 may be a manually activated valve and manually actuated by a user. The conduit 254 may be a flexible hose or any other suitable conduit for provided fluid communication between the outlet 259 and the container 257.

FIG. 2 also illustrates an air purging apparatus 308. The air purging apparatus 308 allows the refrigerant recovery unit 100 to be purged of non-condensable, such as air. Air purged from the refrigerant recovery unit 100 may exit the storage tank 212, through an orifice 312, through a purging valve 314 and through an air diffuser 316. In some embodiments, the orifice may be 0.028 of an inch. A pressure transducer 310 may measure the pressure contained within the storage tank 212 and purge apparatus 308. The pressure transducer 310 may send the pressure information to the controller 216. And when the pressure is too high, as calculated by the controller, purging is required. The valve 314 may be selectively actuated to permit or not permit the purging apparatus 308 to be open to the ambient conditions. A temperature sensor 317 may be coupled to the main tank to measure the refrigerant temperature therein. The placement of the temperature sensor 317 may be anywhere on the tank or alternatively, the temperature sensor may be placed within a refrigerant line 322. The measured temperature and pressure may be used to calculate the ideal vapor pressure for the type of refrigerant used in the refrigerant recovery unit. The ideal vapor pressure can be used to determine when the non-condensable gases need to be purged and how much purging will be done in order for the refrigerant recovery unit to function properly.

High side clearing valves 318 may be used to clear out part of the high-pressure side of the system. The high side clearing valves 318 may include valve 323 and check valve 320. Valve 323 may be a solenoid valve. When it is desired to clear part of the high side, valve 323 is opened. Operation of the compressor 256 will force refrigerant out of the high pressure side through valves 323 and 320 and into the storage tank 212. During this procedure the normal discharge valve 284 may be closed.

A deep recovery valve 324 is provided to assist in the deep recovery of refrigerant. When the refrigerant from the refrigerant system 200 has, for the most part, entered into the refrigerant recovery unit 100, the remaining refrigerant may be extracted from the refrigerant system 200 by opening the deep recovery valve 324 and turning on the vacuum pump 258.

In another embodiment, in order to charge the refrigerant system 200, the power charge valve 326 may be opened and a tank fill structure 332 may be used. Alternatively or in addition to, the tank fill structure 332 may also be used to fill the storage tank 212. In order to obtain refrigerant from a refrigerant source, the refrigerant recovery unit 100 may include the tank fill structure 332, and valves 328 and 330. The tank fill structure 332 may be configured to attach to a refrigerant source. The valve 330 may be a solenoid valve and the valve 328 may be a check valve. In other embodiments, valve 330 may be a manually operated valve.

When it is desired to allow refrigerant from a refrigerant source to enter the refrigerant recovery unit 100, the tank fill structure 332 is attached to the refrigerant source and the tank fill valve 330 is opened. The check valve 328 prevents refrigerant from the refrigerant recovery unit 100 from flowing out of the refrigerant recovery unit 100 through the tank fill structure 332. When the tank fill structure 332 is not connected to a refrigerant source, the tank fill valve 330 is kept closed. The tank fill valve 330 may be connected to and controlled by the controller 216.

The tank fill structure 332 may be configured to be seated on the scale 334 configured to weigh the tank fill structure 332 in order to determine an amount of refrigerant stored in the tank fill structure 332. The scale 334 may be operatively coupled to the controller 216 and provide a measurement of a weight of the tank fill structure 332 to the controller 216. The controller 216 may cause a display of the weight of the tank fill structure 332 on the display 110.

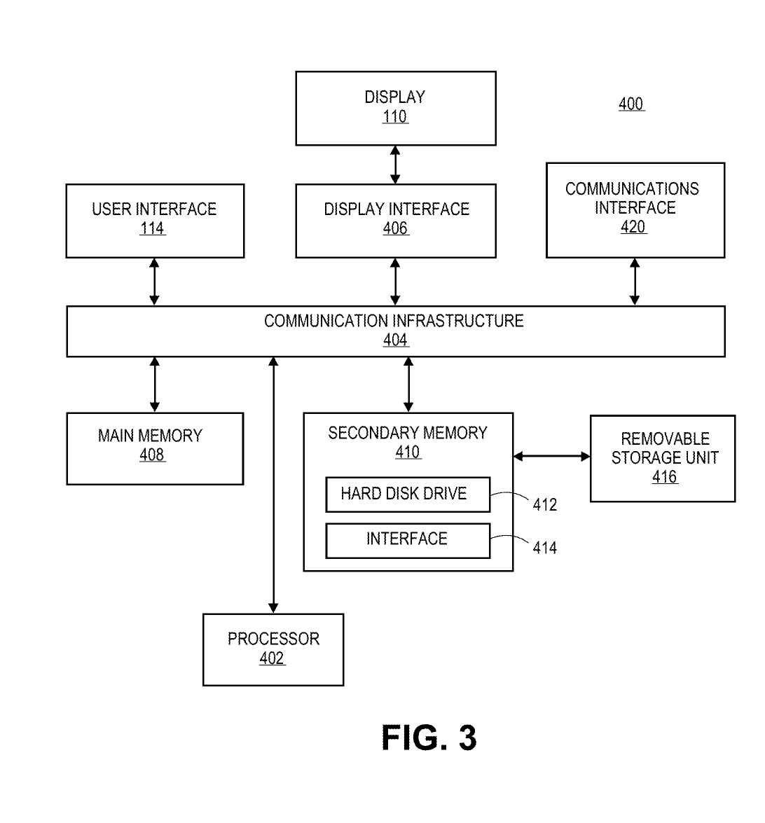

Aspects of the refrigerant recovery unit 100 may be implemented via control system 400 using software or a combination of software and hardware. In one variation, aspects of the present invention may be directed toward a control system 400 capable of carrying out the functionality described herein. An example of such a control system 400 is shown in FIG. 3.

Control system 400 may be integrated with the controller 216 to permit, for example, automation of the recovery, evacuation, and recharging processes and/or manual control over one or more of each of the processes individually. In one embodiment, the control system 400 allows the refrigerant recovery unit to direct communicate and diagnose the vehicle under service. In another embodiment, the control system 400 allows for communication with a diagnostic tool, such as a vehicle communication interface (VCI), that is coupled to the vehicle under service. It should be understood that the VCI does not have to be coupled to a vehicle in order to communicate with the refrigerant recovery unit 100. This allows the refrigerant recovery unit 100 to receive information from the vehicle such as VIN (vehicle identification number), manufacturer, make, model, and odometer information, and vehicle sensor data that pertains to the heating, ventilation, and air conditioning sensors and systems on the vehicle. Data could include A/C and HVAC system sensor readings, A/C and HVAC related diagnostic trouble codes, system pressures, and interactive tests, like actuating of various components, such as a fan control. All of this data and information would be displayed on the display 110 of the refrigerant recovery unit 100. Menu selections, diagnostic trouble codes, and interactive tests may be displayed and certain diagnostic may be performed using the refrigerant recovery unit.

The control system 400 may also provide access to a configurable database of vehicle information so the specifications pertaining to a particular vehicle, for example, may be used to provide exacting control and maintenance of the functions described herein. The control system 400 may include a processor 402 connected to a communication infrastructure 404 (e.g., a communications bus, cross-over bar, or network). The various software and hardware features described herein are described in terms of an exemplary control system. A person skilled in the relevant art(s) will realize that other computer related systems and/or architectures may be used to implement the aspects of the disclosed invention.

The control system 400 may include a display interface 406 that forwards graphics, text, and other data from memory and/or the user interface 114, for example, via the communication infrastructure 404 for display on the display 110. The communication infrastructure 404 may include, for example, wires for the transfer of electrical, acoustic and/or optical signals between various components of the control system and/or other well-known means for providing communication between the various components of the control system, including wireless means. The control system 400 may include a main memory 408, preferably random access memory (RAM), and may also include a secondary memory 410. The secondary memory 410 may include a hard disk drive 412 or other devices for allowing computer programs including diagnostic database (DTC information and repair and diagnostic information) or other instructions and/or data to be loaded into and/or transferred from the control system 400. Such other devices may include an interface 414 and a removable storage unit 416, including, for example, a Universal Serial Bus (USB) port and USB storage device, a program cartridge and cartridge interface (such as that found in video game devices), a removable memory chip (such as an erasable programmable read only memory (EPROM), or programmable read only memory (PROM)) and associated socket, and other removable storage units 416 and interfaces 414.

The control system 400 may also include a communications interface 420 for allowing software and data to be transferred between the control system 400 and external devices. Examples of a communication interfaces include a modem, a network interface (such as an Ethernet card), a communications port, wireless transmitter and receiver, Bluetooth, Wi-Fi, infra-red, cellular, satellite, a Personal Computer Memory Card International Association (PCMCIA) slot and card, etc.

The control system 400 also includes transceivers and signal translators necessary to communicate with the vehicle electronic control units in various communication protocols, such as J1850 (VPM and PWM), ISO 9141-2 signal, communication collision detection (CCD) (e.g., Chrysler collision detection), data communication links (DCL), serial communication interface (SCI), Controller Area Network (CAN), Keyword 2000 (ISO 14230-4), OBD II or other communication protocols that are implemented in a vehicle. This allows the refrigerant recovery unit to communicate directly with the vehicle without the VCI (e.g., directly connected to the vehicle) or while the VCI is simply acting as a pass through.

A software program (also referred to as computer control logic) may be stored in main memory 408 and/or secondary memory 410. Software programs may also be received through communications interface 420. Such software programs, when executed, enable the control system 400 to perform the features of the present invention, as discussed herein. In particular, the software programs, when executed, enable the processor 402 to perform the features of the present invention. Accordingly, such software programs may represent controllers of the control system 400.

In variations where the invention is implemented using software, the software may be stored in a computer program product and loaded into control system 400 using hard drive 412, removable storage drive 416, and/or the communications interface 420. The control logic (software), when executed by the processor 402, causes the controller 216, for example, to perform the functions of the invention as described herein. In another variation, aspects of the present invention can be implemented primarily in hardware using, for example, hardware components, such as application specific integrated circuits (ASICs), field programmable gate array (FPGA). Implementation of the hardware state machine so as to perform the functions described herein will be apparent to persons skilled in the relevant art(s).

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A refrigerant recovery system, comprising:
a recovery apparatus, comprising:
a heat sink;
a capture tank in thermal contact with the heat sink, the capture tank being configured to capture a first refrigerant from a refrigeration system; and
a hose to fluidly connect the capture tank to the refrigerant system; and
a refrigerant recovery unit, comprising:
a refrigerant storage unit configured to store a second refrigerant;
a refrigerant circuit in fluid connection with the heat sink, the refrigerant circuit configured to supply the second refrigerant to the heat sink;
a processor configured to control the refrigerant recovery unit; and
a memory to store diagnostic software and operating software to operate the refrigerant recovery unit.

2. The refrigerant recovery system according to claim 1, wherein the recovery apparatus further includes an expansion valve disposed at the heat sink to control the flow of the second refrigerant to the heat sink.

3. The refrigerant recovery system according to claim 1, wherein the recovery apparatus further includes an evaporator disposed at the heat sink to provide a volume for the second refrigerant to expand into and absorb heat from the heat sink.

4. The refrigerant recovery system according to claim 1, wherein the refrigerant recovery unit further comprises:
an input interface configured to receive an input from a user; and
a display configured to display information to the user.

5. The refrigerant recovery system according to claim 1, wherein the recovery apparatus further includes an insulating jacket.

6. The refrigerant recovery system according to claim 1, wherein the refrigerant recovery unit further includes a compressor to urge the second refrigerant to flow through the refrigerant circuit.

7. The refrigerant recovery system according to claim 1, wherein the refrigerant recovery unit further includes a filter/dryer to filter and dry the second refrigerant.

8. The refrigerant recovery system according to claim 1, wherein the refrigerant recovery unit is further configured to recover and recharge the refrigerant in the refrigerant system.

9. The refrigerant recovery system according to claim 1, wherein the refrigerant recovery unit further includes an oil separator to remove an oil from the second refrigerant.

10. The refrigerant recovery system according to claim 1, further comprising:
a pair of hoses to fluidly connect the refrigeration recovery unit to the heat sink.

11. A recovery device, comprising:
a heat sink;
a capture tank in thermal contact with the heat sink, the capture tank being configured to capture a first refrigerant from a refrigeration system; and
a hose to fluidly connect the capture tank to the refrigerant system.

12. The recovery device according to claim 11, further comprising:
a pair of hoses to circulate a second refrigerant through the heat sink and remove heat from the heat sink.

13. The recovery device according to claim 12, further comprising:
an expansion valve disposed at the heat sink to control the flow of the second refrigerant to the heat sink.

14. The recovery device according to claim 12, further comprising:
an evaporator disposed at the heat sink to provide a volume for the second refrigerant to expand into and absorb heat therefrom.

15. The recovery device according to claim 12, further comprising:
a piezoelectric cooler thermally coupled to the heat sink.

16. A method of recovering contaminated or flammable refrigerant from a refrigeration system, the method comprising the steps of:
cooling a capture tank to a temperature below a condensing temperature of a first refrigerant;
supplying a second refrigerant to a heat sink in thermal contact with the capture tank, the second refrigerant drawing heat from the heat sink;
fluidly connecting the capture tank to the refrigeration system; and
generating a pressure differential with a relatively low pressure in the capture tank by condensing the first refrigerant that enters the capture tank and causing the first refrigerant in the refrigeration system to flow into the capture tank.

17. The method according to claim 16, further comprising the step of:
filling the heat sink with the second refrigerant in liquid phase;
stopping a flow of the second refrigerant to the heat sink in response to the heat sink being full; and
drawing off the second refrigerant in vapor phase from the heat sink.

18. The method according to claim 16, further comprising the step of:
controlling an expansion of the second refrigerant in the heat sink to draw the heat from the heat sink.

19. The method according to claim 16, further comprising the step of:
fluidly connecting a refrigerant recovery unit to the heat sink to supply the second refrigerant to the heat sink.

20. The method according to claim 19, further comprising the step of:
isolating the first refrigerant captured in the capture tank from the second refrigerant.
